(19) United States
(12) Patent Application Publication
(10) Pub. No.: US 2011/0208508 A1
(43) Pub. Date: Aug. 25, 2011

(54) Interactive Language Training System

(76) Inventor: Shane Allan Criddle, Spokane, WA (US)

(21) Appl. No.: 13/030,476

(22) Filed: Feb. 18, 2011

Related U.S. Application Data
(60) Provisional application No. 61/308,064, filed on Feb. 25, 2010.

(51) Int. Cl. G06F 17/27

(52) U.S. Cl. 704/9; 704/E11.001

(57) ABSTRACT

An interactive language training system allows practice word/phrase lists customized by the user for training. The customized lists may include words/phrases extracted from content sources based upon user selections. Extraction may include analysis of the content sources to determine word/phrase frequency, topic, and/or other parameters. A video sample of a student speaking a word/phrase is compared with video examples of a speaker and provides visual feedback for pronunciation and articulation. Progress is monitored for each word/phrase on the list, and performance feedback provided. Communication, such as voice or video chat may be established between the student and a speaker to provide for additional practice.

### PRIORITY

The present application claims priority to U.S. Provisional Application Ser. No. 61/308,064, filed on Feb. 25, 2010, entitled “INTERACTIVE LANGUAGE TRAINING SYSTEM.” This pending application is herein incorporated by reference in its entirety, and the benefit of the filing date of this pending application is claimed to the fullest extent permitted.

### BACKGROUND

Learning a new language can be an arduous task. The learning process may also be complicated when there is a scarcity of native speakers and/or writers available for a student to learn from.

Various schemes have been put forth to teach languages. However, these schemes provide rigid frameworks for learning, which do not provide for flexibility and dynamic interaction.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an architecture in which an interactive language training system operates.

FIG. 2 is a block diagram of functional components used to implement the interactive language training system.

FIG. 3 illustrates a user interface (UI) of the interactive language training system configured to accept user characteristics.

FIG. 4 illustrates a UI of the interactive language training system configured to build and maintain customized list of words/phrases.

FIG. 5 illustrates a UI of the interactive language training system configured to present the customized list of words/phrases and progress of a student for the words/phrases therein.

FIG. 6 illustrates a UI of the interactive language training system configured to present a lesson for one of the words from the customized word list.

FIG. 7 illustrates a UI of the interactive language training system configured to compare and analyze an example from a speaker with a sample from the student.

FIG. 8 illustrates a UI of the interactive language training system configured to present a word scramble written exercise to the student showing words/phrases in the student's native language and providing an opportunity to enter answers in a target language.

FIG. 9 illustrates a UI of the interactive language training system configured to present a word scramble written exercise to the student showing words/phrases in the target language and providing an opportunity to enter answers in the student's native language.

FIG. 10 illustrates a UI of the interactive language training system configured to present content such as an online newspaper in the target language, as well as a hover tool allowing words/phrases in the content to be added to the customized word list.

FIG. 11 illustrates a UI of the interactive language training system configured to present a test to assess the fluency of the student in the target language.

FIG. 12 illustrates a UI of the interactive language training system configured to display overall proficiency and fluency in the target language.

FIG. 13 illustrates a UI of the interactive language training system configured to display users, including students, who are available for communication.

FIG. 14 illustrates a UI of the interactive language training system configured to facilitate intercommunication between the users.

FIG. 15 is a flow diagram of a process for generating a custom list of words/phrases for study by a student.

FIG. 16 is a flow diagram of a process for updating custom lists based upon external content.

FIG. 17 is a flow diagram of a process for comparing a sample from a user with a reference sample to generate a similarity score.

FIG. 18 is a flow diagram of a process for facilitating communication between users of an interactive language training system.

### DETAILED DESCRIPTION

This disclosure describes an interactive language training system which provides for a rich and engaging environment for learning a target language. The target language may comprise letters, words, phrases, and so forth. For convenience and not by way of limitation, “words” as used in this application shall indicate letters, words, phrases, and so forth, unless otherwise explicitly stated.

With this interactive language training system, student users achieve fluency in the target language through a variety of interactive exercises and goals involving letters, words, and phrases. Students register with the system, and build customized word and phrase lists for study using tools available in the system. These custom word and phrase lists may be based at least in part upon a particular academic area of interest (such as law, sociology, medicine, computer science, and so forth) or a general area of interest (such as pop culture, movies, science fiction, and so forth). These customized word lists improve student interest by providing a desired subject, while also improving fluency in a particular subset of the target language.

Content, such as online books, newspapers, magazines, and so forth, may also be used to build custom word lists. For example, content in the target language may be accessed, categorized, and the words/phrases within analyzed. These words and phrases may be ranked by frequency of occurrence, placement within the content, and other factors, to find words which may be of interest. Once identified, categories and custom word lists may be enhanced to include these words/phrases.

In some implementations, users may select specific content for analysis and inclusion of words. For example, a student studying structural engineering may choose a journal in this topic area, to help find words and phrases in the target language which are specific to that specialty.

Words and phrases may also be added to customized word lists via a hover tool integrated into a web browser or other application. During presentation of material within the web browser or other application, a student may select a particular word or phrase. Once selected, the student may view a definition, see their current fluency level with the word or phrase, add the word or phrase to their customized list, and so forth. This allows the student to easily expand and enhance their customized word list, and thus their set of practice words and phrases, to more accurately represent their needs.

The system tracks progress with regards to learning the words and phrases present on the customized lists. Monitoring user's interactions with the words or phrases is used at least in part to determine fluency. These interactions may include tests, lessons, accuracy of use during communications with others, and so forth. A pre-determined fluency threshold may be set, such that once that threshold has been achieved, the student is considered to be fluent with that word or phrase. The pre-determined fluency threshold may be set by the student, the instructor, an administrator, another party, or a combination thereof.

Words and phrases presented to the student during lessons are adaptable to the age, gender, and other characteristics of the student. Some languages vary terms, inflections, pronunciations, and so forth based upon the characteristics of the speaker. For example, in some languages pronunciation of a word may vary when the speaker is a young male compared to pronunciation by an adult female. A student may select and practice words and phrases in the target language appropriate to their characteristics. Thus, the student learns a more fluent variation of the language.

The customized word and phrase lists may be augmented with practice content. Practice content includes materials retrieved from sources in the target language. These materials include books, internet content, and so forth. Practice content may also be adjusted to match the characteristics of the student. For example, a sample news article presented to the young male student may differ from a sample news article presented to the adult female.

Practice exercises and lessons may include scrambling words or phrases from the customized lists, and calling for the student to recognize the words within the scramble. By providing a fun and engaging exercise, learning of the target language is enhanced.

Video capture improves pronunciation and articulation of words in the target language. Video clips of words and phrases in the target language are captured, and may be presented in conjunction with lessons. These video clips may be adapted based on the characteristics of the student, as described above. Thus, the young male student may see video of a young male speaker saying a word or phrase in the target language. Additionally, video of the student may be captured. This video may be played back in real-time to provide the student with immediate feedback as to pronunciation and articulation, or stored and played back for later review by the student or an instructor.

In some implementations, the video of the speaker in the target language is synchronized with the video of the student. Thus both the video of the speaker and the student may be played back about simultaneously and in step with one another. This allows the student or an instructor the capability to compare the pronunciation and articulation of the student with that of the speaker. The sounds uttered to produce a word or phrase are pronunciation, while articulation is the mechanical movements of elements of the vocal tract which contribute to the generation of the sounds.

Comparison between the student and speaker may be manual, automatic, or a combination. In one implementation manual comparison may utilize a viewer observing both and providing an assessment. In another implementation, comparison may be partially or fully automatic. For example, a facial tracking module may analyze movements of both the student and speaker's face, and compare those movements. A score may be assessed based on the similarity of the articulation. For example, a student which has done a very good job articulating the word of phrase may be presented with a similarity score of 92%.

Comparison of audio between the speaker and student may also be used to determine similarity, particularly for pronunciation. For example, the waveforms of both the speaker and student may be presented for comparison. This comparison may be manual, partially, or fully-automated. A similarity score may be provided. Comparison of audio and video may be combined, allowing for analysis of articulation as well as pronunciation.

Comparison may also be made of written communications. For example, a student may be assigned to translate a passage from the target language. Based on the accuracy of the student's translation, a score may thus be assigned.

Providing communication between native speakers of the target language and students of the target language enhances the learning experience. Furthermore, such communication enhances the fluency of both parties, particularly when each is interested in achieving fluency in the other's language. For example, an American student may be learning Korean while a Korean student is learning American English. A communication channel may be established between the students, allowing each to practice with one another. In other implementations, the parties may be student and instructor, student and a person conducting a language test, and so forth.

Tools are provided within the system to enable communication between the parties. A list of those parties wishing to participate is maintained, and users may access this list to find others. Presentation of parties may be filtered in some implementations according to user characteristics. These characteristics may include age, gender, residency, education level, religious beliefs, social affiliations, level of fluency in the target language, and so forth. For example, a male elementary school student may only see other male elementary school students at about the same level of language studies.

In one implementation, this list may be presented graphically via a user interface in the form of a map, with users indicated thereon based on their respective geographic location. Continuing our example from above, the Korean student may thus see represented on a map an American student in Texas is available. Wishing to establish communication, the Korean student may select an icon representing the American student, and begin communication. In another implementation, an instructor may designate parties to communication, such as Chin Ho in Korea will communication with Thomas in Texas.

Communication may be provided via several methods including email, text chat, video chat, audio chat, telephone, mail, in-person, and so forth. Where the communication uses an alternative network such as mail, telephone, or involves an in-person meeting, information about how and when to establish the communication may be exchanged. For example, the American student may wish to call via the telephone network the Korean student, and thus request and receive (with the Korean student's approval) the Korean student's telephone phone number.

In some implementations, the parties may consent to evaluation of their communication. This evaluation may be manual, partially, or fully automated. For example, a manual evaluation may involve an instructor joined into the communication to observe and assess the performance of both the Korean and American students.

### Architectural Environment

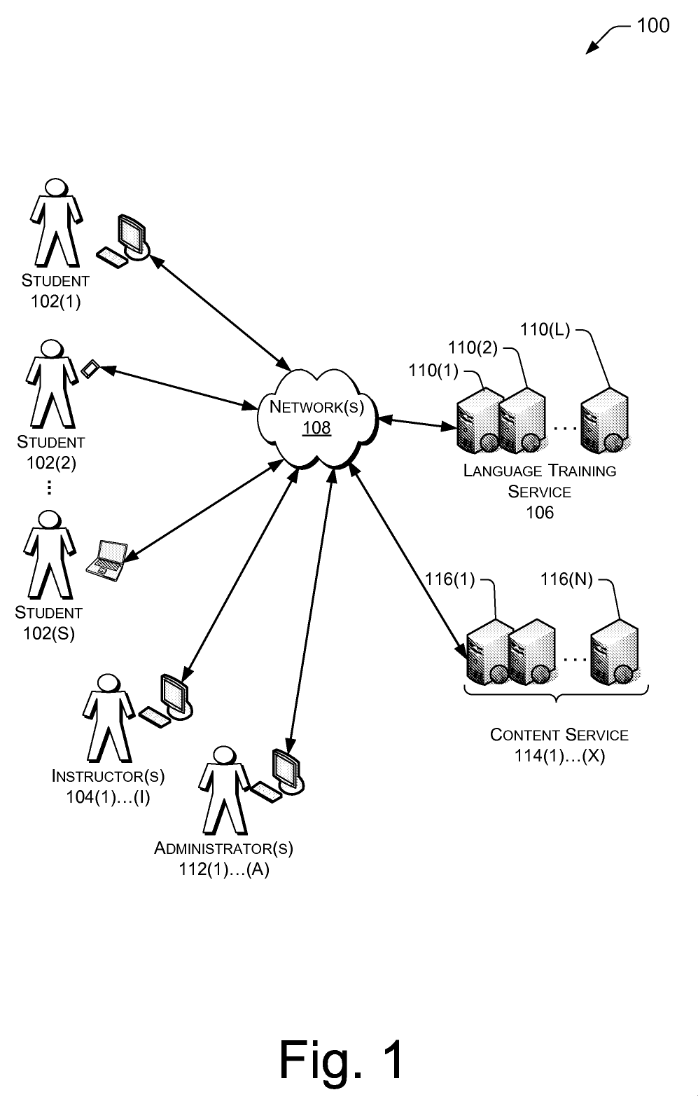

FIG. 1 illustrates an architecture 100 in which an interactive language training system operates. Users, such as students 102(1), 102(2), . . . 102(S) and instructors 104(1), . . . 104(I) may use devices such as laptops, netbooks, smartphones, personal computers, and so forth to access a language training service 106 via network 108. The network 108 is representative of any one or combination of multiple different types of networks, such as the Internet, cable networks, cellular networks, wireless networks, WiFi networks, and wired networks.

The language training service 106 is hosted on one or more servers 110(1), 110(2), . . . , 110(L). The servers 110(1)-(L) collectively have processing and storage capabilities to support a language training service 106. The servers 110(1)-(L) may be embodied in any number of ways, including as a single server, a cluster of servers, a server farm or data center, and so forth, although other server architectures (e.g., mainframe) may also be used. Administrators 112(1), . . . , 112(A) may also access the language training service 106 via the network 108 to provide for maintenance of the language training service 106.

The servers 110(1)-(L) further support communication over the network 108 with one or more other services, such as content services 114(1), . . . , 114(X). Content services may provide content such as newspapers, magazines, books, audio, video, and so forth for consumption by users. The language training service 106 and one or more of content services 114(1)-(X) may be owned and operated by the same entity or a separate entity.

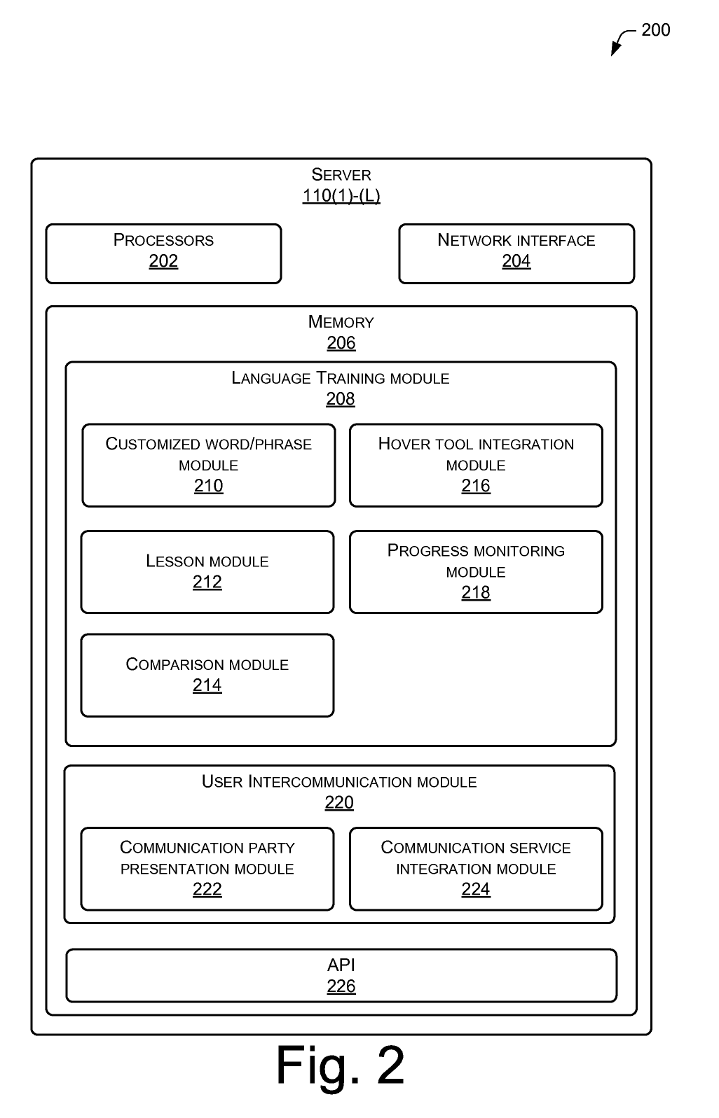

FIG. 2 is a block diagram of selected modules in a representative computer system 200 that may be used to implement the language training service 106 hosted on one or more of servers 110(1)-(L).

In this example, the servers 110(1)-(L) include one or more processors 202 and a network interface 204 configured to allow communication with the network 108. Also shown is a memory 206. The memory 206 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Stored within the memory 206 may be a language training module 208. The language training module may comprise several additional modules as described next. A customized word/phrase module 210 provides and maintains customized word/phrase/letter lists for users. These customized lists may be generated from one or more input sources. The input sources include a student 102, an instructor 104, an administrator 112, a pre-existing list obtained from a third party, or generated by the customized word/phrase module 210 after accessing content services 114(1)-(X).

The customized word/phrase module 210 may be configured to access content, such as available upon content services 114(1)-(X) and identify words/phrases suitable for inclusion in the customized word lists.

The customized word/phrase module 210 enables the creation of a plurality of groups or categories for analysis. For instance, content services 114(1)-(X) may be analyzed to compile a conversational English list. Content services 114(1)-(X) may be specified to allow for gathering specialized words/phrases, such as jargon specific to a particular field of study. For example, computer science related academic journals may be scanned to build up an academic word list in that category. Content which has been analyzed may be distributed into categories as well as sub categories such as religion, politics, law, engineering, telecom, etc. Thus, a continually growing number of lists are created by the customized word/phrase module 210 and stored in a datastore for access by the users.

In some implementations, the customized word/phrase module 210 may assign a category to a uniform resource location (URL). This categorization may then result in words from that source being appended to subordinate sub-categories.

The customized word/phrase module 210 may analyze content to determine characteristics about the words/phrases appearing therein. For example, a count of the words by category may be maintained and ranked. The customized word/phrase module 210 may also track the word usage as well as phrase usage, order and relative position of words/phrases, and so forth within content. Once tracked and ranked, the customized word/phrase module 210 may then generate and update the custom lists.

A lesson module 212 is configured to generate lessons suitable for students 102(1)-(S). For example, the lesson module 212 may be configured to access the custom lists generated by the customized word/phrase module 210, and provide interactive examples such as a native speaker saying the word or phrase, written samples, and so forth. The lesson module 212 may also provide testing and assessment interfaces in conjunction with the progress monitoring module 218 described below.

A comparison module 214 is configured to accept samples from a student 102 and compare that sample with a reference sample. The reference sample may be obtained from a fluent speaker, such as an instructor 104, or in some instances, a student 102 who is a native speaker of the target language. The comparison module may be configured to analyze audio data, video data, written data, and so forth to determine a similarity score between the student sample and the reference sample.

A hover tool integration module 216 may also be present within the language training module 208. In some implementations, the hover tool integration module 216 may work in conjunction with a plug-in within the user's web browser. The hover tool integration module 216 provides language tools to users while they consume content, such as that from content services 114(1)-(X). For example, while reading an online newspaper, a user may select a word. The hover tool integration module 216 may provide a definition of the selected word, an option to add this word to the user's custom word list, or a proficiency store if the word already appears in the user's custom word list, and so forth.

Furthermore, use of the hover tool integration module 216 may be used to determine at least in part proficiency. For example, repeated access by the student 102 to the hover tool integration module 216 to define a particular word may be demonstrate a low level of fluency. The progress monitoring module 218 may adjust the student's 102 level of fluency accorded to the word downward, at least in part due to the repeated access of that word.

A progress monitoring module 218 may be present within language training module 208. The progress monitoring module 218 may work in conjunction with the other modules such as the customized word/phrase module 210, the lesson module 212, the comparison module 214, and the hover tool integration module 216 to assess fluency.

Fluency may be determined by consistent performance with regards to the target language. Fluency may also vary by user characteristics, goals of the student 102, outcomes set by the instructor 104, and so forth. For example, fluency for a 10 year old child may differ from an adult which desires focused fluency in a technical area such as engineering. Fluency may include verbal skills in the target language as well as literacy with the written form of the target language.

The progress monitoring module 218 may also provide presentations to users of their progress. For example, charts indicating fluency with particular words/phrases may be indicated, as well as an overall indication of fluency in the target language.

Memory 206 may also store a user intercommunication module 220. The user intercommunication module is configured to provide for the facilitation and in some implementations establishment of communication between users such as students 102(1)-(S), instructors 104, and combinations thereof.

The user intercommunication module 220 may comprise a communication party presentation module 222. The communication party presentation module 222 is configured to determine which parties such as students 102, instructors 104, and so forth are available for communication. Once the parties are determined, the communication party presentation module 222 presents at least a portion of these available users. A communication service integration module 224 may be configured to work in conjunction with the communication party presentation module 222. The communication party presentation module 222 is configured to establish communications either via an internal communication channel such as a chat hosted by the language training service 106 or by an outside communication service such as a third party video chat service.

The functionality provided by the various components of the language training service 106, as described above, may be exposed through a collection of APIs 226. The APIs 226 may allow interaction between various platforms such as the content services 114(1)-(X). The APIs 226 may include, for example, functions for (1) analyzing words/phrases in content, (2) adding words/phrases featured in the content to a customized word list, (3) assessing fluency based upon questions relating to content presented to the student, and so forth.

### User Interfaces

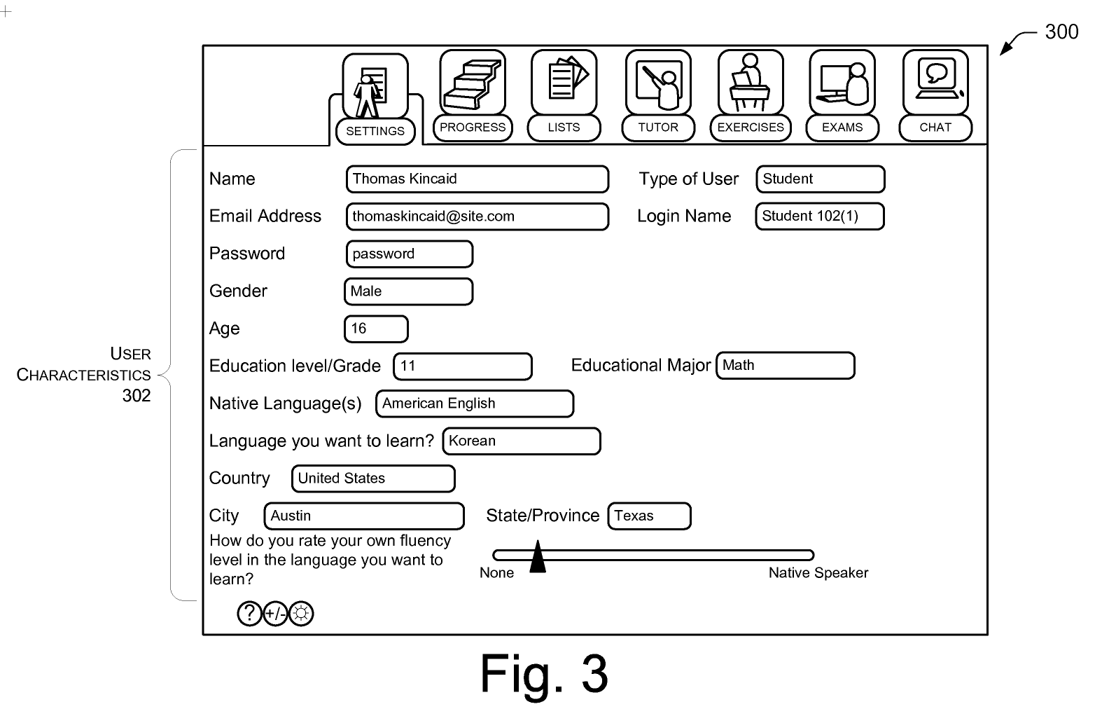

FIG. 3 illustrates a user interface (UI) 300 of the interactive language training system configured to accept user characteristics 302. The user characteristics 302 may include name, email address, login, password, and so forth. User characteristics 302 may also include details about the user's status, such as type of user (student, instructor, administrator, and so forth), gender, age, educational level, educational details, native language(s), target language(s), residency, self-assessed fluency, and so forth. User characteristics 302 may be stored in a datastore which is accessible to the language training module 208.

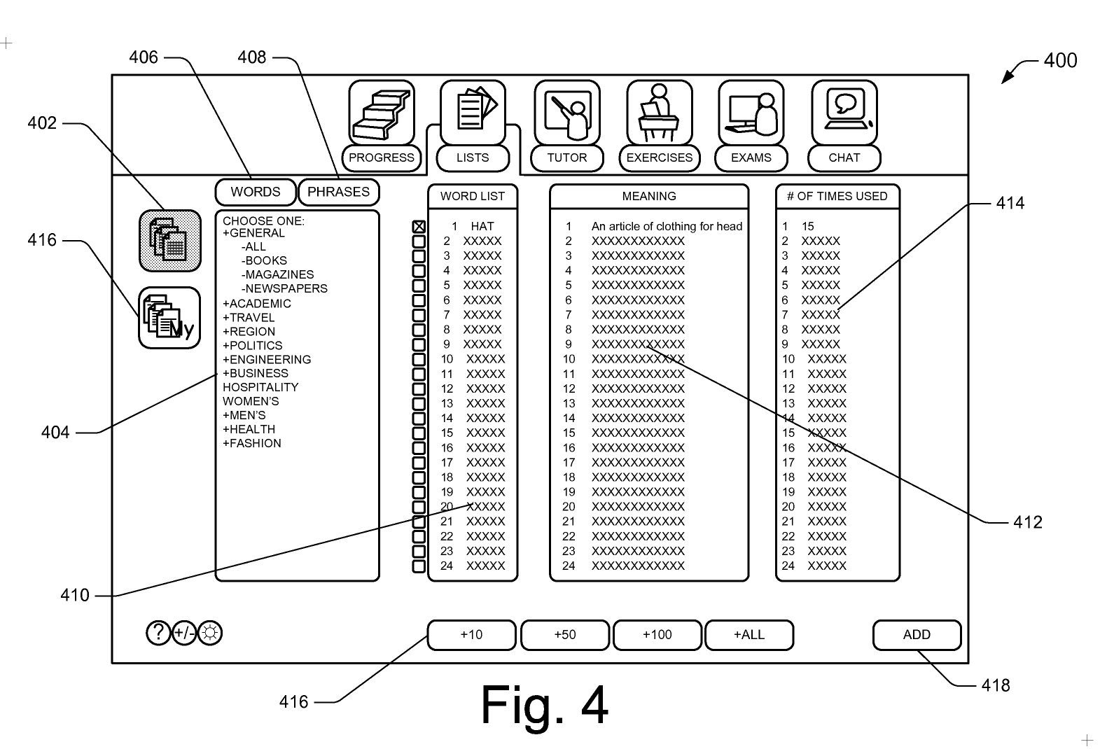

FIG. 4 illustrates a UI 400 of the interactive language training system configured to build and maintain customized lists of words/phrases. A user interface selection control 402 is presented which when activated provides the user interface shown here. Within this UI is presented a list of available word list categories 404. Categories may include politics, engineering, business, hospitality, and so forth. A words control 406 presents the user with a list of words associated with a selected available category. Similarly, a phrases control 408 presents the user with a list of phrases associated with the selected available category. A word list 410 shows the words/phrases which are present in a selected category as ranked. The rankings may be by frequency of occurrence within the category, frequency within a particular piece of content, placement, complexity of definition, and so forth. The user may select words and phrases from the word list 410 for inclusion into the user's custom word list.

A meaning 412 or definition may be presented for each word, as well as details about the ranking 414. For example, as shown here the word list 410 includes “hat” with the meaning 412 of “an article of clothing for head . . . ” and the ranking 414 indicates that this word was ranked number one with a number of times used or frequency of 15. As described above, in other implementations the ranking may be based upon frequency, placement, complexity of definition, and so forth.

A user may be presented with controls to manipulate the word lists. For example, as shown here controls 416 may be configured to allow the selection of the next 10, 50, 100, or all words in the list. Upon selection, an add control 418 may be used to place those words into the user's customized list. Once words have been added to the user's customized list, the user may use a control to view 416 the custom list.

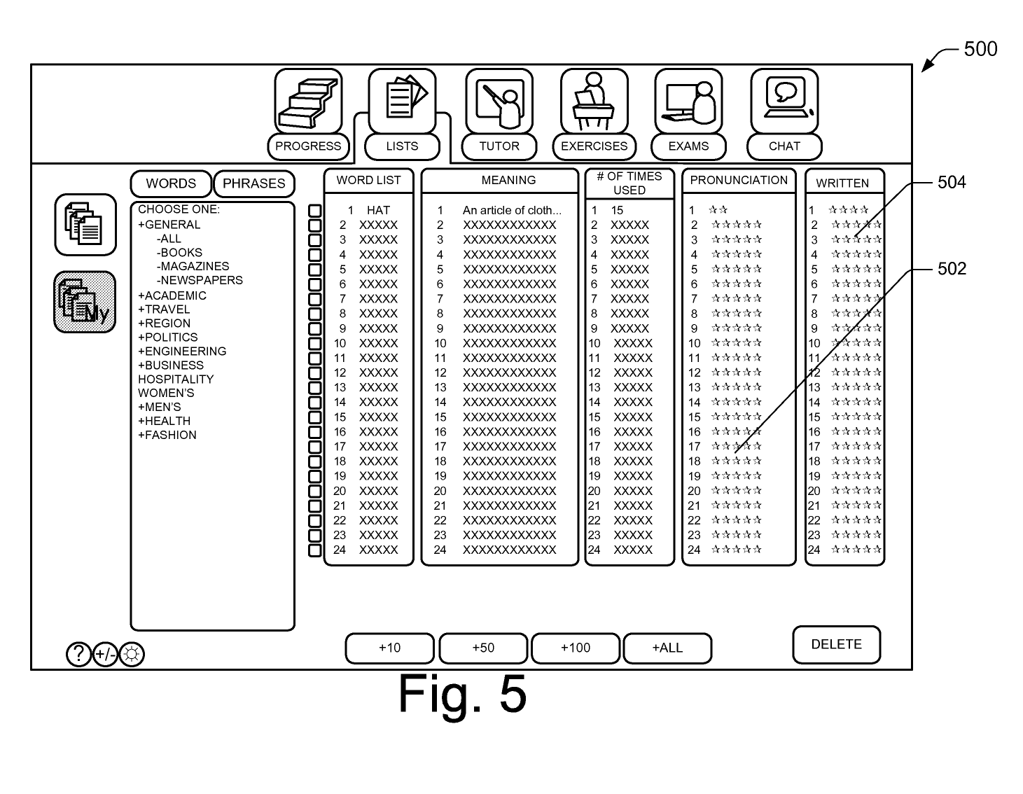

FIG. 5 illustrates a UI 500 of the interactive language training system configured to present a user's customized list of words/phrases and progress of a student for the words/phrases therein. While similar to the UI 400 described above, in this UI 500, additional information is presented indicating progress for the words on the customized word list. A pronunciation progress 502 for each word on the custom list may be presented as shown here. In this example, the more stars the user has, the greater the fluency with that word. Thus, in this example the user is still working on the pronunciation of the word for “hat” as indicated by the two stars. For written communications, a written progress 504 is also shown indicating the user's facility with the written form of the word. Thus, in this example, the user has almost mastered the written word for “hat,” as indicated by the four stars.

Progress may be assessed by the progress monitoring module 218, using input from the lesson module 212, comparison module 214, hover tool integration module 216, and so forth. For example, upon receiving a 60% or better similarity score in pronouncing the word for “hat,” an additional star may be added to the pronunciation progress 502 for the word.

A user may select words or categories which are in the custom list for additional emphasis and training. For example, a student planning a shopping trip may wish to focus on learning words for different articles of clothing.

The custom list may evolve over time as the student becomes fluent with some words or categories of words, removing some words while adding new ones. Similar to FIG. 4, controls may also be present for adding, removing, and otherwise maintaining the user's custom word list.

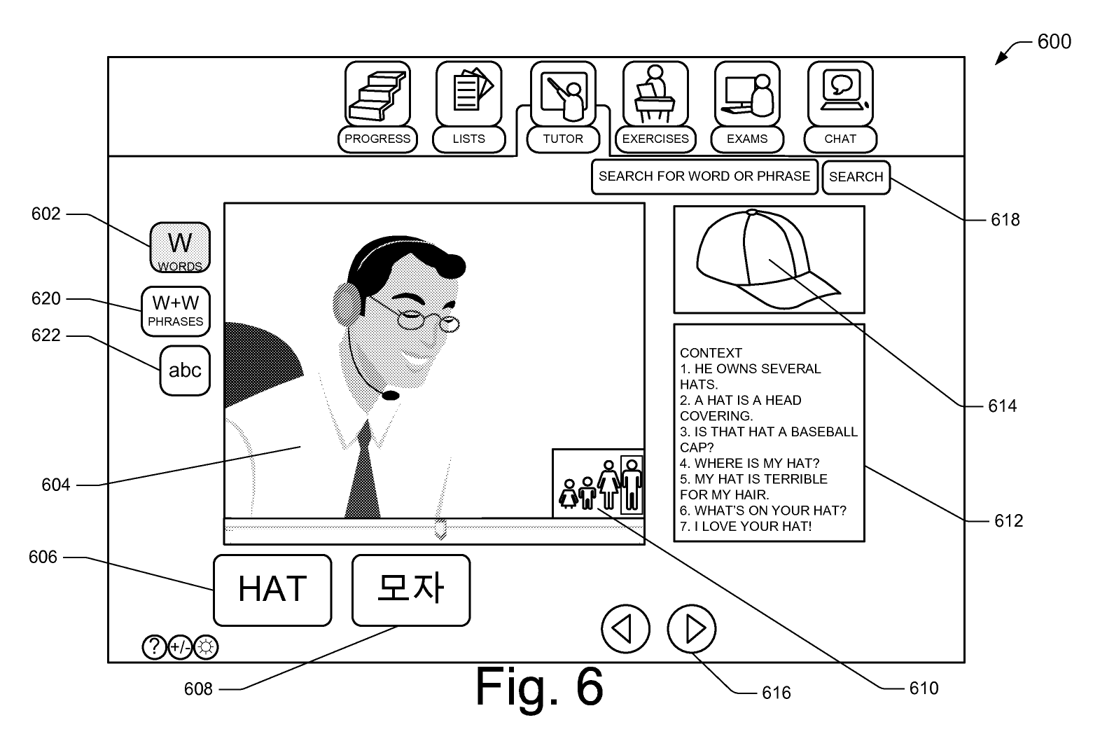

FIG. 6 illustrates a UI 600 of the interactive language training system configured to present a lesson for one of the words from the user's customized word list. A user interface selection control 602 is presented which when activated provides the user interface shown here. Within this user interface the student 102 may view a video 604 of a speaker saying one of the words/phrases/letters from the student's 102 custom list. The word/phrase/letter may be shown 606 along with the translation into the target language 608. In some implementation, audio may be presented in lieu of video. Also, in some implementations a control may be provided allowing the speed of video or audio playback to be increased or decreased, facilitating a user's ability to observe details of the speaker.

Because word choice, pronunciation, and other factors may vary in a target language based upon differences in age or gender, a user may select a control 610 to see a speaker with a different age, gender, or other characteristic. Such selection may be set to a default based upon the user preferences 302. This selection may also be used to address cultural constraints, such as when the student 102 is not permitted certain actions, such as viewing video of an un-related female and so forth. As shown here, an adult male speaker has been selected.

Contextual samples 612 may be presented to the student 102. Contextual samples may include samples of the word used in different phrases. Other information may also be presented, such as definitions, cultural significance, and so forth. An image or video 614 of the word or phrase may also be presented. This provides a visual cue which may aid in retention and building of fluency.

A user may use navigation controls 616 to move between words, phrases, letters, and so forth. Search controls 618 may also be used to navigate among the student's 102 custom list.

A user interface selection control 620 is presented which when activated may provide with a user interface similar to the UI 600 but used for studying phrases. Another user interface selection control 622 may allow similar functionality for the study of individual letters.

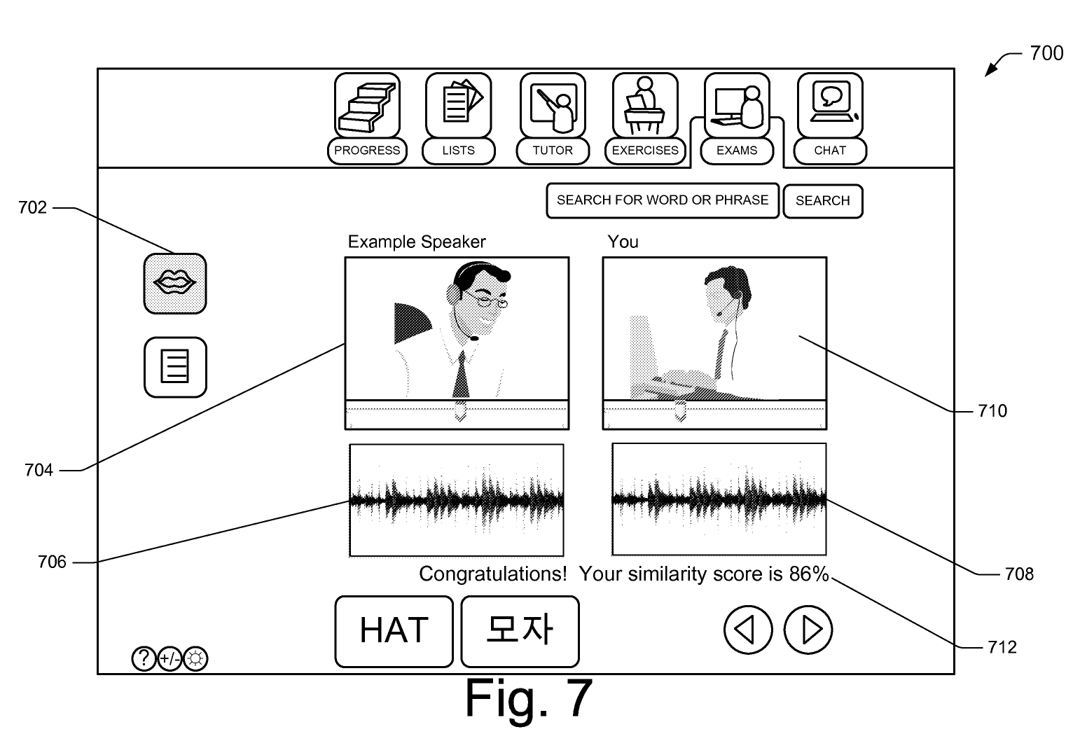

FIG. 7 illustrates a UI 700 of the interactive language training system configured to compare and analyze an example from a speaker with a sample from the student. A user interface selection control 702 is presented which when activated provides the user interface shown here. For a word, phrase, or letter from the custom list, a video or audio file 704 of the example speaker saying the word may be presented. A visual representation of the example speaker's audio 706 may be presented as well. Using a camera, an image of the student 102 repeating the word is captured. This video of the student 102 may be presented 710, and a visual representation of the student's 102 attempt to say the word 708 may also be provided.

The video, audio, or both, of the student 102 may be compared with that from the example speaker to determine a similarity score 712. The similarity score may be determined at least in part by the comparison module 214. Similarity may be determined based on correspondence between data from the example speaker and the student. This data may include comparison of audio data, video data such as facial movements, and so forth.

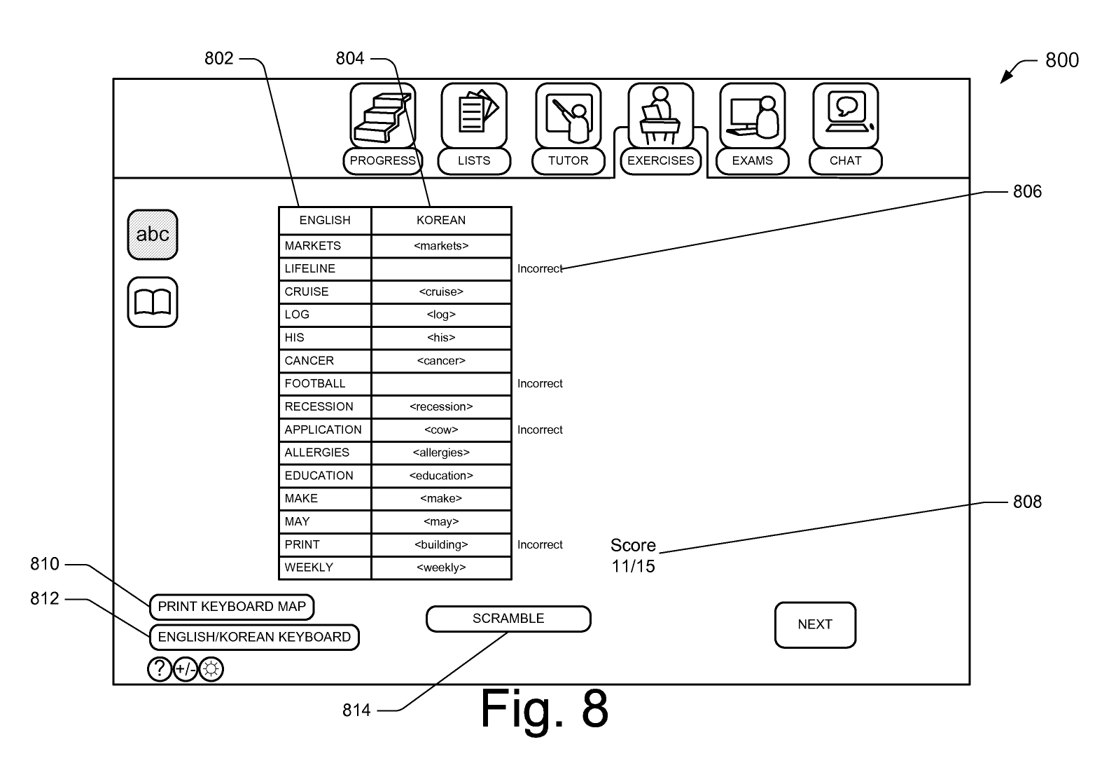

FIG. 8 illustrates a UI 800 of the interactive language training system configured to present a word scramble. This provides an opportunity for the student 102 to practice spelling and further practice with words/phrases.

As shown here, words/phrases in the student's 102 native language are presented 802 and an opportunity given for the student 102 to enter answers in the target language 804. For clarity of illustration, words in the target language are indicated within brackets. For example, “<markets>” represents the Korean word for “markets.”

Indicia 806 of a failure to answer or an incorrect answer is presented and may be registered for use by the progress monitoring module 218 to update the student's 102 progress for a given word, as well as overall progress. A score 808 may be presented to the student 102, indicating how many words were correctly entered in the target language.

To facilitate entry of letters, several controls may be presented. A control to print a keyboard map 810 may be presented. Upon activation, this control may output via a printer a map of keyboard keys and their corresponding counterparts in the target language. A control to display an onscreen keyboard or toggle between the native language and the target language on the keyboard 812 may also be presented. A control to scramble the words which are presented and toggle languages 814 is shown.

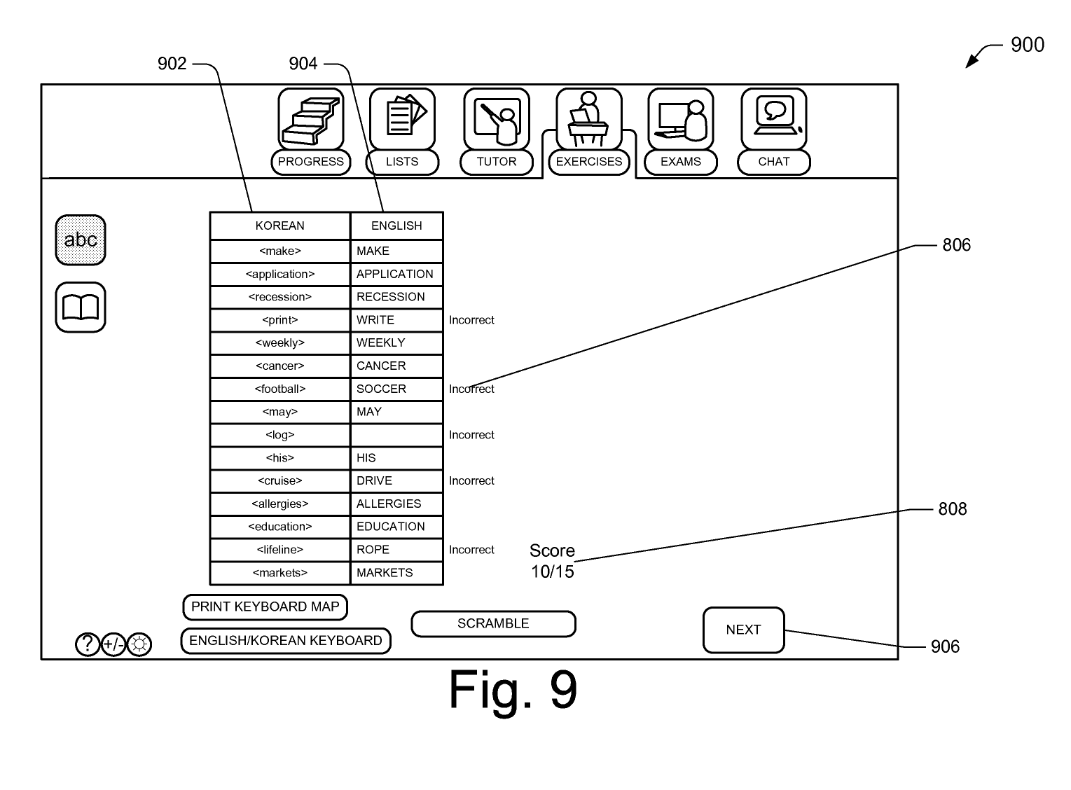

FIG. 9 illustrates a UI 900 of the interactive language training system configured to present a word scramble after actuation of the scramble control 814. This UI 900 is similar to the UI 800 of FIG. 8. As shown here, words/phrases in the student's 102 target language are presented 902 and an opportunity given for the student 102 to enter answers in the native language 904.

Upon activation of a next control 906, a set of the next ten words, phrases, letters, or a combination thereof is selected. This set may include words/phrases/letters which have previously been indicated as mastered by the progress monitoring module 218, to aid in continued retention of the material.

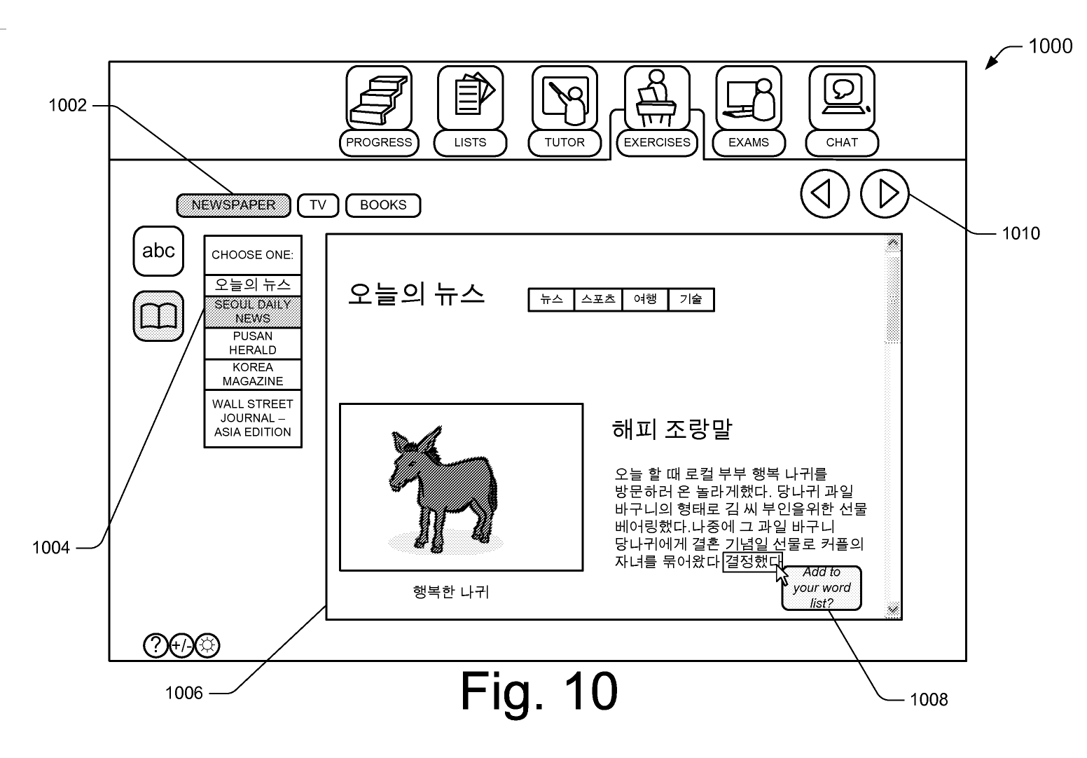

FIG. 10 illustrates a UI 1000 of the interactive language training system configured to present content such as an online newspaper in the target language. Learning a language is improved by using and experiencing that language. Content in the target language from content services 114(1)-(X) may be accessed, and utilized to provide such an experience.

A control to select a type of content 1002 may be presented. For example, as shown here newspaper content may be provided, while TV, books, and so forth may be selected. Within the type of content, a selection of content items 1004 may be presented. In this example, the “Seoul Daily News” has been selected, and is presented within a window 1006.

Also shown here is the student's 102 mouse pointer and selection of the word “ [symbol] .” The hover tool integration module 216 may be utilized to present a control 1008 which when activated adds this selection to the student's 102 custom list, or presents other information about this selection. For example, if the selection is already on the custom list, details about the student's 102 proficiency with the word may be presented. Other information such as related words, definitions, and so forth, may also be provided. By providing the hover tool and functionality from the hover tool integration module 216, the user may more easily and seamlessly interact with content in the target language.

Browser controls 1010 may also be presented. These controls may allow further navigation, selection, and other internet browser related functions. Furthermore, in some implementations, the hover tool control 1008 may be presented as a plug-in or add-on to an internet browser. This plug-in may operate independently using locally stored data, or access data stored within the language training service 106.

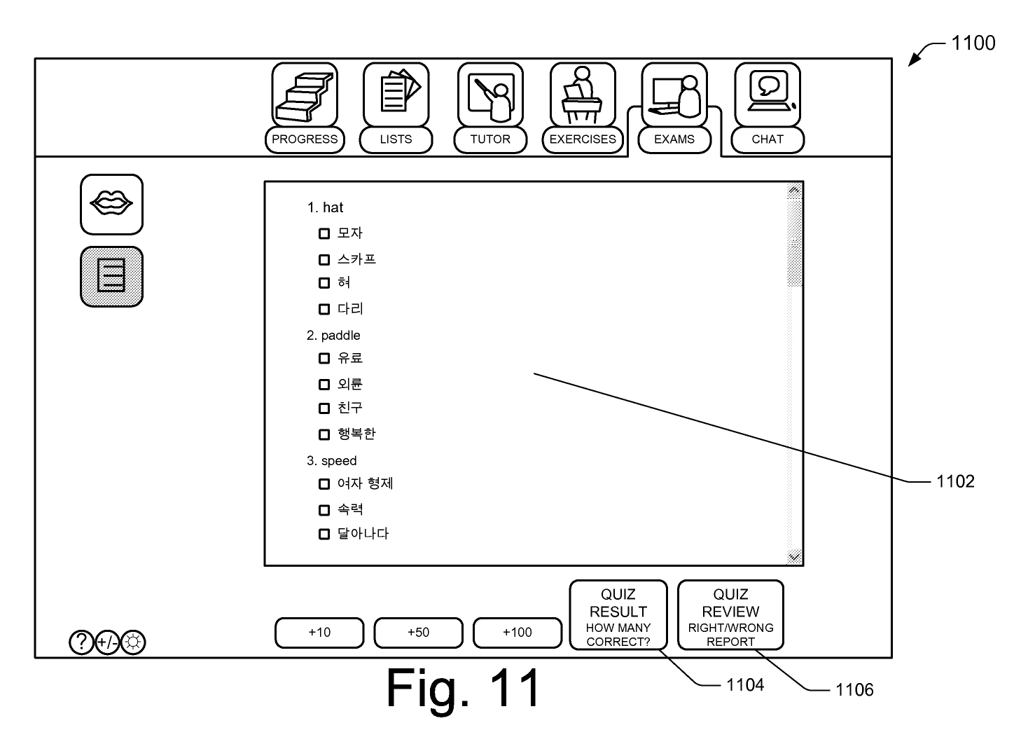

FIG. 11 illustrates a UI 1100 of the interactive language training system configured to present a multiple choice test. Results from this test may be used by the progress monitoring module 218 to assess the fluency of the student 102 with respect to the words/phrases/letters tested.

As shown here a window 1102 shows words from the custom word list for testing. In some implementations, words which have been correctly tested a pre-determined number of times, indicating fluency, may be removed from routine testing. As described above, words which have been fluently learned may be re-introduced for testing on a basis less frequent then non-fluent words to reinforce memory and aid in the retention of fluency.

Other controls may be shown to add additional words to the test. Other controls may display quiz results 1104, review correct and incorrect answers in the quiz 1106, and so forth.

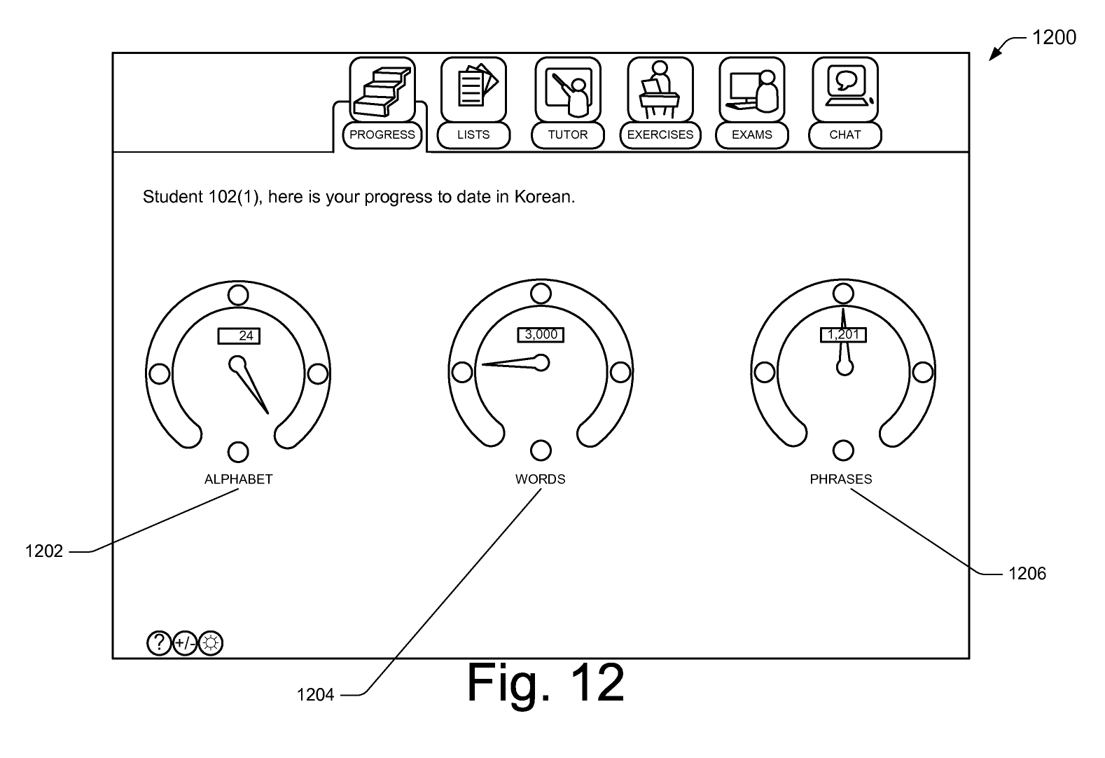

FIG. 12 illustrates a UI 1200 of the interactive language training system configured to display overall proficiency and fluency in the target language for a particular student. This user interface 1200 may be supported at least in part by the progress monitoring module 218.

The UI 1200 may demonstrate progress with regards to several metrics and in several areas. As shown here, the metrics are a record of a pre-determined number of successful answers for each of the areas including letters, words, and phrases. In other implementations, metrics may include comprehension, writing, conversational flow, and so forth.

As shown in this example, the student 102(1) is reviewing his progress in learning the target language Korean. As shown here, an alphabet indicator 1202 indicates that the student 102 has mastered all 24 of the Hangul characters found in the written Korean language.

A words indicator 1204 indicates that the student 102(1) has mastered 3,000 words, and is about one-quarter of the way to go to reach the pre-determined level of fluency. This pre-determined level of fluency may be set by the student 102, the instructor 104, the administrator 112, or may be dynamically adjusted by the interactive language training service 106 itself.

A phrases indicator 1206 indicates the number of phrases which have been mastered by the student 102(1). In this example, the student 102(1) is proficient with 1,201 phrases, about half of the phrases which have been determined to be required for fluency.

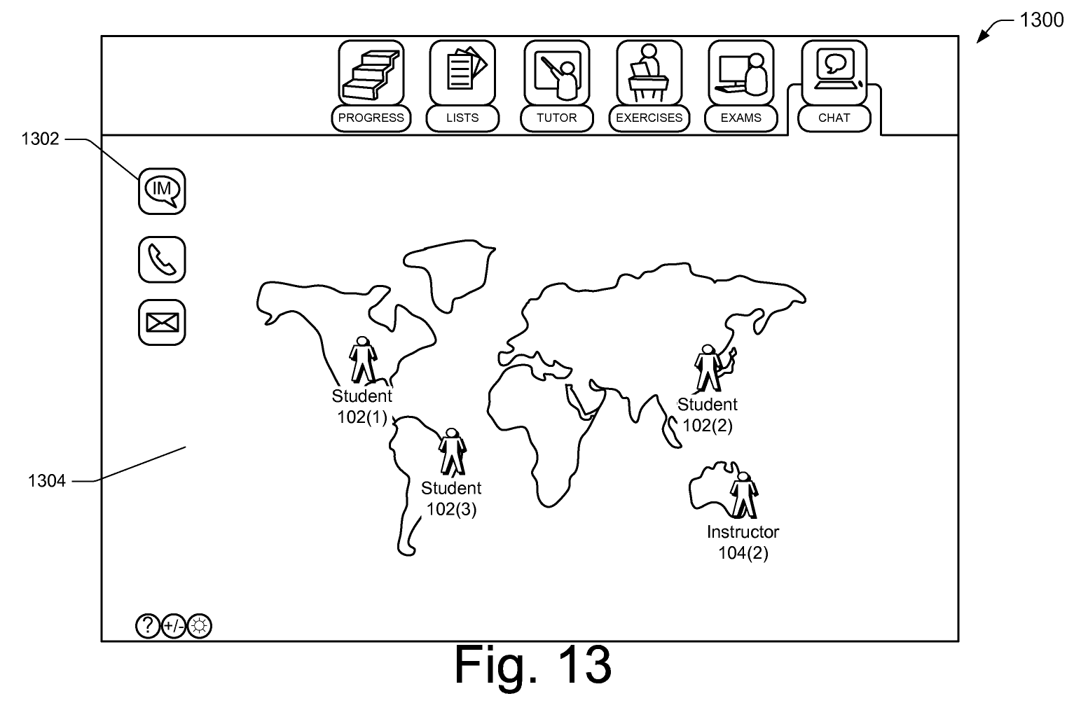

FIG. 13 illustrates a UI 1300 of the interactive language training system configured to display users, including students, who are available for communication. An excellent way to learn a language is to use that language in an exchange. However, it can be difficult to locate parties who wish to participate in that exchange, particularly parties who are native speakers.

The UI 1300 works in conjunction with the user intercommunication module 220 to display users such as student 102(1)-(S) and instructors 104(1)-(I) who are available for communication. This communication may be written such as via instant messaging or email, voice through a web chat or telephone call, video chat, regular mail, and so forth.

Users may select to see available users using various filters. For example, the student 102(1) may wish to see only those users who are available at this moment for a video chat in Korean. The communication may further be filtered to match up users with corresponding language interests. For example, the student 102(1) who natively speaks American English and is learning Korean may be matched with the student 102(2) who natively speaks Korean and is learning American English. In this way, the parties may be able to help one another in their respective native languages.

Controls to initiate communication 1302 may be presented, which upon activation initiate the establishment of a communication between two or more users. Various representations of available users may be presented, including lists, maps, and so forth. Shown here is a world map 1304, including representations of at least a portion of the currently available users. The student 102(1) is shown in the United States, the student 102(2) is shown in South Korea, a student 102(3) is shown in South America while an instructor 104(2) is shown in Australia. Upon selection of one or more of these available users, communication may be initiated.

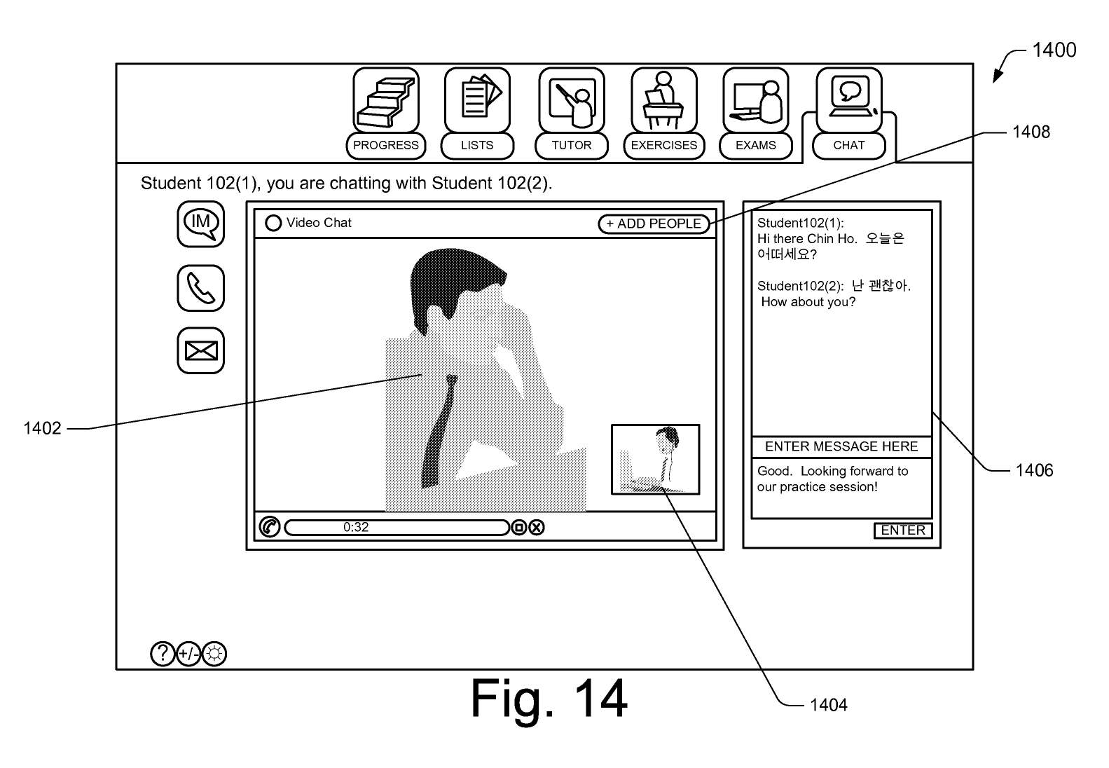

FIG. 14 illustrates a UI 1400 of the interactive language training system configured to facilitate intercommunication between the users. In the example shown here, two users are shown conversing via video chat. A video image 1402 of the far-end of the chat is shown, in this example the student 102(2) in Korea. Also shown is a video image 1404 of the near-end of the chat, in this case the student 102(1). A text messaging interface 1406 may also be provided with controls to enter, edit, review, save, and otherwise interact with written communications. A control to add people 1408 to the chat may also presented. For example, if both parties in the chat are floundering and unable to understand each other, they may add in an instructor 104 to assist.

### Processes of the Interactive Language Training System

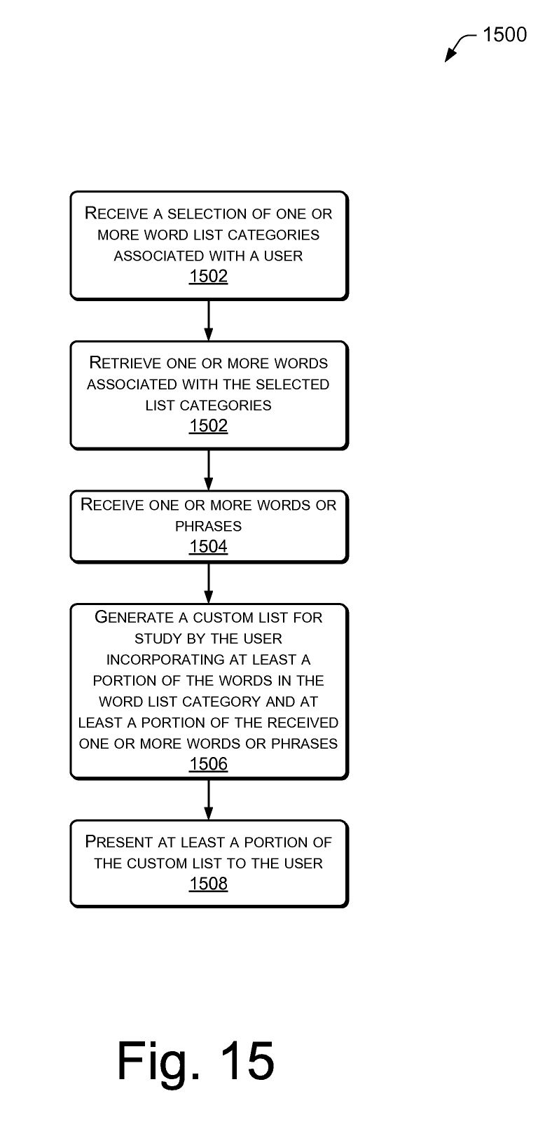

FIGS. 15-18 show processes 1500, 1600, 1700, and 1800 of a language training service. The processes 1500-1800 are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 1500-1800 are described with reference to the architecture and interfaces of FIGS. 1-14.

FIG. 15 is a flow diagram of a process 1500 for generating a custom list of words/phrases for use by the student 102, instructor 104, or other user. This process may be implemented using the customized word/phrase module 210 as described above.

Block 1502 receives a selection of one or more word list categories. This selection is associated with a particular user. Once one or more categories have been selected, block 1502 retrieves one or more words associated with the selected list categories. For example, a user selection of a category of “fashion” may retrieve words such as hat, scarf, pants, dress, and so forth.

Block 1504 receives one or more words or phrases, such as those which have been selected or input by a user. For example, a user may select words using the hover tool and related functions of the hover tool integration module 216.

Block 1506 generates a custom list of letters, words, phrases, and so forth for study by the user. This custom list comprises at least a portion of the retrieved words from the selected list categories and may also comprise at least a portion of the received one or more words or phrases. Once generated, the custom list, personalized for a particular user, may be stored within a datastore for later retrieval and use.

Block 1508 presents at least a portion of the custom list to the user. For example, a subset of the list may be presented during the scramble word practice described above with respect to FIGS. 8-9.

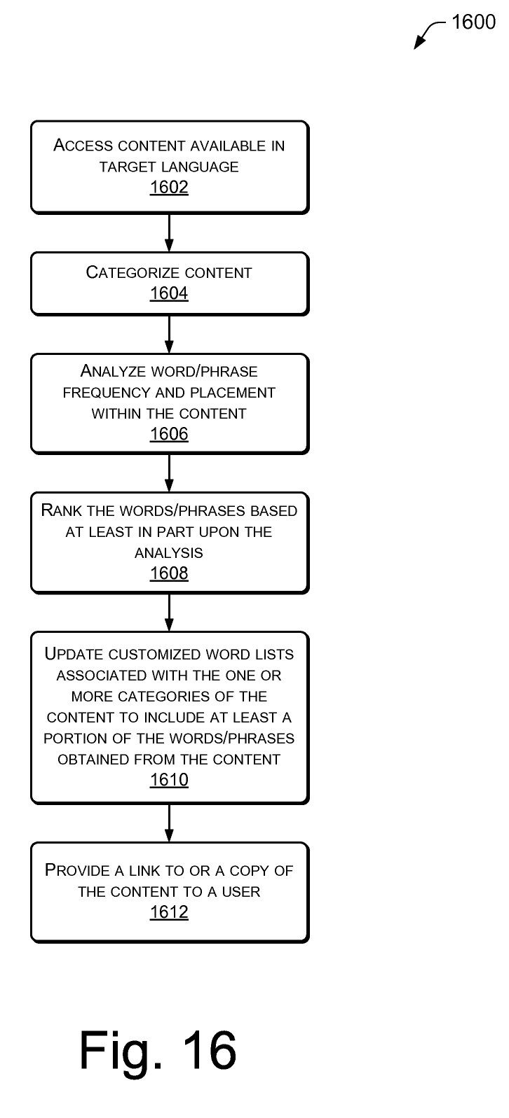

Given the ebb and flow of topics and interests, words and phrases necessary to obtain fluency in a language may change over time. Furthermore, manually updating custom lists to reflect these changes may become unwieldy. FIG. 16 is a flow diagram of a process 1600 for updating custom lists based upon external content.

Block 1602 access content available in a target language. For example, the customized word/phrase module 210 in the language training service 106 may access content stored on content service 114(1).

Block 1604 categorizes the content. This categorization may be made based on frequency of specialized words, semantic analysis, and so forth. In some implementations a particular piece of content, such as an article or a book, may be categorized. In other implementations, the entire site may be categorized. For example, where the content service 114(1) is a newspaper, all content accessed from that content service may be categorized as “news.”

Block 1606 analyzes the accessed content. For example, word/phrase frequency, placement within the content, and other parameters of the content may be determined.

Block 1608 ranks the words/phrases from the content based at least in part upon the analysis. For example, the top 100 words or phrases from the content may be ranked based upon their frequency of occurrence within the news articles on content service 114(1).

This ranking may also be used to determine the order of presentation during language training. For example, words with a high frequency of use may be designated for more frequent study.

Block 1612 provides a link or copy of the content to the user of the language training service 106. For example, as shown above with respect to FIG. 10, the user may be presented with a web interface showing the content at the content service 114.

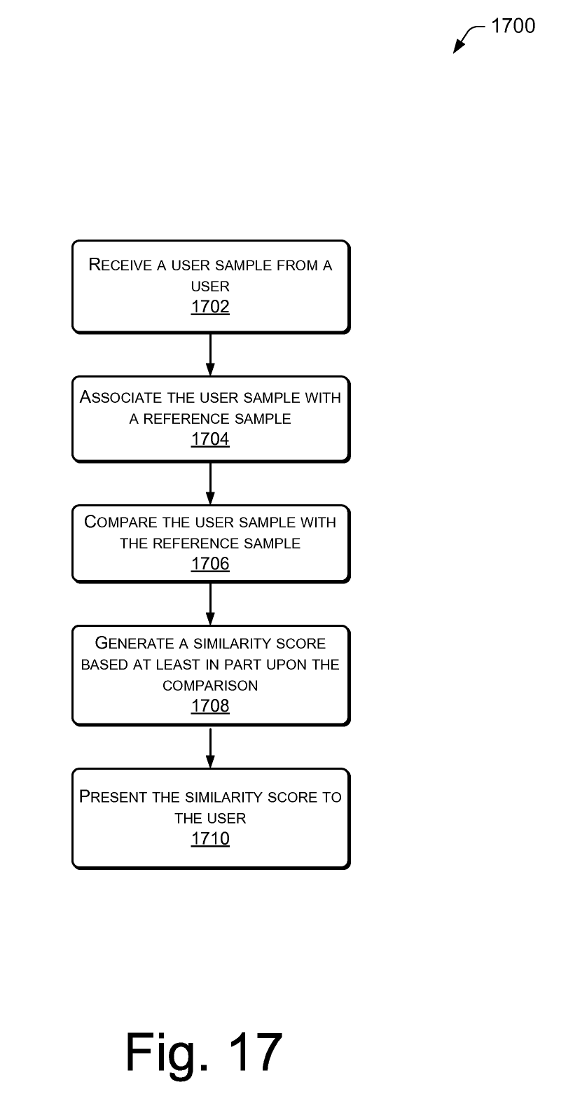

FIG. 17 is a flow diagram of a process 1700 for comparing a sample from a user with a reference sample to generate a similarity score. The process 1700 may be used with regards to comparison of audio, video, textual, or other samples involved in language training. The process 1700 may be implemented by the comparison module 214 of the language training service 106.

Block 1702 receives a sample from a user. This user sample may comprise audio, video, textual, and so forth. For example, the sample of the user saying the word “hat” in Korean may be audio and video captured by a webcam on the user's netbook computer.

Block 1704 associates the user sample with a reference sample. The reference sample is such that it represents a usable example of the target language. For example, the sample may be an audio and video capture of an instructor or native speaker saying the word “hat” in Korean.

Block 1706 compares the user sample with the reference sample. This comparison may include comparison of waveforms, movement of facial features, analysis of speech components such as phonemes, and so forth.

Block 1708 generate a similarity score based at least in part upon the comparison. For example, when the phonemes uttered in the user sample correspond to those in the reference sample, a high degree of similarity may be said to exist. This degree of similarity may be quantified and used to generate a numeric score or ratio, such as a percentage of similarity, with 100% being an exact duplicate of the reference sample.

Block 1710 presents the similarity score to the user. For example, as shown above with respect to the user interface of FIG. 7, element 712.

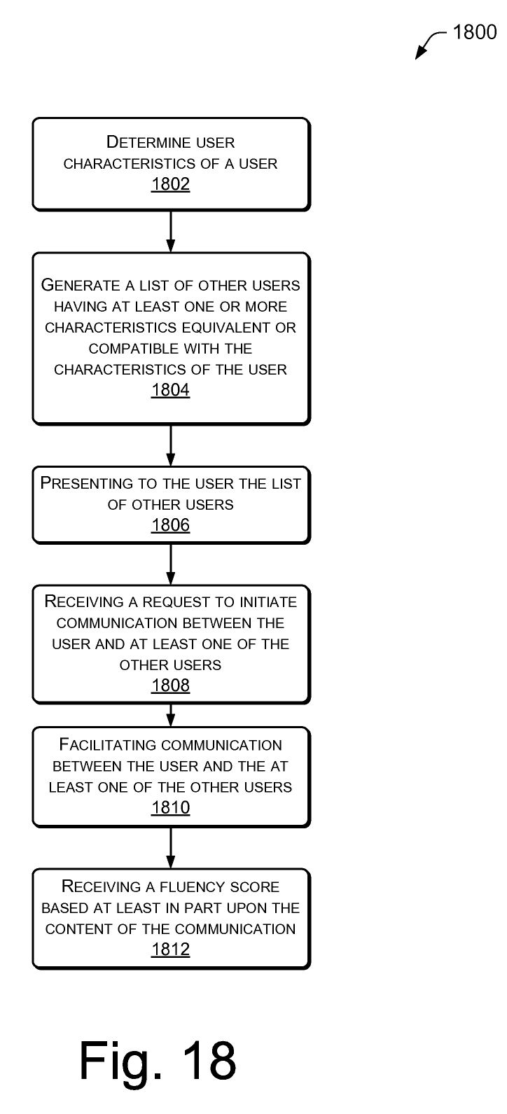

FIG. 18 is a flow diagram of a process 1800 for facilitating communication between users of an interactive language training system. As described above with respect to FIG. 13, communication between users of the language training service 106 may be facilitated to encourage fluency. The process 1800 may be implemented by the user intercommunication module 220 of the interactive language training service 106.

Block 1802 determines the user characteristics of a first user. For example, the student 102(1) may be a 16 year old male with a native language of American English who is learning Korean.

Block 1804 generates a list of other users suitable for communication which have at least one or more of characteristics which are equivalent or compatible with the characteristics of the first user. The threshold used to define equivalence and compatibility may vary by characteristic, user preferences, and so forth. For example, an equivalent user age may be the age of the user plus or minus two years. In another example, a compatible user may be one which speaks natively the target language of the first user.

Block 1806 presents to the first user the list of the other users who are suitable for communication. This list may be presented in the form of a tabular list, graphic such as shown with regards to FIG. 13 above, and so forth.

Block 1808 receives a request to initiate communication between the first user and at least one of the other users which were presented on the list of users suitable for communication. For example, returning to FIG. 13 above, student 102(2) may have been selected for a video chat session.

Block 1810 facilitates communication between the first user and the at least one other user. In some implementations this may involve initiating an internal chat session, initiating a communication using a third party service, and so forth.

Block 1812 receives a fluency score based at least in part upon the content of the communication which was facilitated. In some implementations this may be gathered from scorings and rankings by one user of another user, by a party such as an instructor which reviewed at least a portion of the communication, or by an automated system. For example, an automated system may use speech recognition to determine what words and phrases were used, and assess their fluency based upon sentence construction, pacing of speech, and so forth.

### CONCLUSION

Although specific details of illustrative methods are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and methods described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

What is claimed is:

1. A system for language training, the system comprising:
a customized word/phrase module comprising a customized list of words/phrases;
a lesson module configured to a present language lessons incorporating at least a portion of the customized list;
an audio/video comparison module configured to determine a degree of similarity between an example of a word/phrase and a sample of a user using the phrase; and
a progress monitoring module configured to provide progress information to the user based at least in part on the degree of similarity determined for the word/phrase.

2. The system of claim 1, further comprising a user intercommunication module configured to facilitate communication between two or more users for language practice.

3. The system of claim 1, wherein the customized word/phrase module is further configured to generate the customized list at least in part due to selection of a user of a category.

4. The system of claim 3, wherein the category is a field of interest or a topic.

5. The system of claim 1, wherein the lesson module is configured to present words from the customized list based in part upon a user preference to display a male or female tutor.

6. The system of claim 1, wherein the lesson module is configured to display:
a video of an instructor speaking the word or phrase; or
a video of the user speaking the word or phrase; or both.

7. The system of claim 6, wherein the lesson module is configured to synchronize the video of the instructor speaking the word or phrase with the video of the user speaking the word or phrase:

8. The system of claim 1, wherein the audio/video comparison module is configured to detect and present to the user differences between the facial movements of the instructor and the user, the audio waveforms of the instructor and the user, or both.

9. The system of claim 1, wherein the lesson module is configured to accept a user input specifying a particular word or phrase for emphasis during one or more lessons.

10. The system of claim 1, further comprising a hover tool integration module configured to designate words or phrases presented during consumption of online content for inclusion into the customized list.

11. The system of claim 10, wherein the hover tool integration module comprises at least in part a plug-in of a web browser.

12. A method for building a customized list for language training, the method comprising:
receiving a selection of one or more list categories associated with a user;
retrieving one or more words associated with the selected list categories;
receiving one or more words associated with the user; and
generating a custom list comprising the retrieved one or more words and the received one or more words.

13. The method of claim 12, wherein the words comprise individual words, phrases, or both.

14. The method of claim 12, wherein the receiving further comprises receiving a word selected by a user during consumption of online content.

15. The method of claim 12, further comprising:
receiving a sample of the user speaking or writing at least one of the words in the custom list;
associating the user sample with a reference sample;
comparing the user sample with the reference sample; and
generating a similarity score based at least in part upon the comparison of the user sample with the reference sample.

16. The method of claim 15, wherein the comparing comprises analyzing audio data, comparing video data, or comparison both audio and video data.

17. The method of claim 12, further comprising:
facilitating communication between the user and one or more other users based at least in part on user characteristics.

18. The method of claim 17, further comprising assessing the fluency of the one or more other users during the communication.

19. A system for language training, the system comprising:
one or more content providers;
a server comprising a processor and a memory, the memory storing instructions, that when executed:
access content from the one or more content providers;
determine the category of the content;
analyze word/phrase frequency and placement within the content;
rank the word/phrases based at least in part on the analysis;
append words/phrases found within the content which meet a pre-determined frequency threshold to a customized list associated with the category.

20. The system of claim 19, further comprising instructions, that when executed:
store a link to the content or a copy of the content.
